(19) United States
(12) Patent Application Publication
(10) Pub. No.: US 2025/0301123 A1
(43) Pub. Date: Sep. 25, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Yang WANG, Beijing (CN); Kai ZHANG, Los Angeles, CA (US); Li ZHANG, Los Angeles, CA (US)

(21) Appl. No.: 19/229,836

(22) Filed: Jun. 5, 2025

Related U.S. Application Data
(63) Continuation of application No. PCT/CN2023/136270, filed on Dec. 4, 2023.

(30) Foreign Application Priority Data
Dec. 5, 2022 (WO) PCT/CN2022/136580

(51) Int. Cl. H04N 19/105; H04N 19/176

(52) U.S. Cl. CPC H04N 19/105; H04N 19/176

(57) ABSTRACT

Embodiments of the disclosure provide a solution for video processing. A method for video processing is proposed. The method includes: determining, for a conversion between a video unit of a video and a bitstream of the video, whether to apply an intra block copy (IBC) and local illumination compensation (LIC) (IBC-LIC) mode to the video unit; in accordance with a determination of applying the IBC-LIC mode to the video unit, deriving, a refined prediction of the video unit by applying the IBC-LIC mode to the video unit, wherein deriving the refined prediction of the video unit comprises: obtaining a prediction of the video unit by applying the IBC to the video unit; and obtaining the refined prediction of the video unit by applying the LIC to the prediction; and performing the conversion based on the refined prediction.

### CROSS REFERENCE

This application is a continuation of International Application No. PCT/CN2023/136270, filed on Dec. 4, 2023, which claims the benefit of International Application No. PCT/CN2022/136580, filed on Dec. 5, 2022. The entire contents of these applications are hereby incorporated by reference in their entireties.

### FIELDS

Embodiments of the present disclosure relates generally to video processing techniques, and more particularly, to intra block copy with local illumination compensation.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video, whether to apply an intra block copy (IBC) and local illumination compensation (LIC) (IBC-LIC) mode to the video unit; in accordance with a determination of applying the IBC-LIC mode to the video unit, deriving, a refined prediction of the video unit by applying the IBC-LIC mode to the video unit, wherein deriving the refined prediction of the video unit comprises: obtaining a prediction of the video unit by applying the IBC to the video unit; and obtaining the refined prediction of the video unit by applying the LIC to the prediction; and performing the conversion based on the refined prediction sample. In this way, it can improve coding efficiency.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining, for a conversion between a video unit of a video and a bitstream of the video, whether to apply an intra block copy (IBC) and local illumination compensation (LIC) (IBC-LIC) mode to the video unit; in accordance with a determination of applying the IBC-LIC mode to the video unit, deriving, a refined prediction of the video unit by applying the IBC-LIC mode to the video unit, wherein deriving the refined prediction of the video unit comprises: obtaining a prediction of the video unit by applying the IBC to the video unit; and obtaining the refined prediction of the video unit by applying the LIC to the prediction; and generating the bitstream based on the refined prediction.

In a fifth aspect, a method for storing a bitstream of a video is proposed. The method comprises: determining, for a conversion between a video unit of a video and a bitstream of the video, whether to apply an intra block copy (IBC) and local illumination compensation (LIC) (IBC-LIC) mode to the video unit; in accordance with a determination of applying the IBC-LIC mode to the video unit, deriving, a refined prediction of the video unit by applying the IBC-LIC mode to the video unit, wherein deriving the refined prediction of the video unit comprises: obtaining a prediction of the video unit by applying the IBC to the video unit; and obtaining the refined prediction of the video unit by applying the LIC to the prediction; generating the bitstream based on the refined prediction; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example of encoder block diagram of VVC;

FIG. 5 illustrates several intra prediction modes;

FIG. 6A and FIG. 6B illustrate reference samples for wide-angular intra prediction;

FIG. 7 illustrates problem of discontinuity in case of directions beyond 45°;

FIG. 8 illustrates example of motion vector scaling for temporal merge candidate;

FIG. 9A and FIG. 9B illustrate MMVD search point;

FIG. 10 illustrates an example of local illustration compensation;

FIG. 11 illustrates no subsampling for the short side;

FIG. 12 illustrates IBC reference region depending on current CU position;

FIG. 13 illustrates examples of symmetry in screen content pictures;

FIG. 14A illustrates an illustration of BV adjustment for horizontal flip;

FIG. 14B illustrates an illustration of BV adjustment for vertical flip;

FIG. 15 illustrates an intra template matching search area used;

FIG. 16 illustrates templates used to derive the parameters of LIC for IBC;

FIG. 17 illustrates samples used to drive IBC-LIC parameters for the templates;

FIG. 18 illustrates adjusted reference template when RR-IBC is horizontal flip;

FIG. 19 illustrates adjusted reference template when RR-IBC is vertical flip;

FIG. 20 illustrates a flowchart of a method for video processing in accordance with embodiments of the present disclosure; and

FIG. 21 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

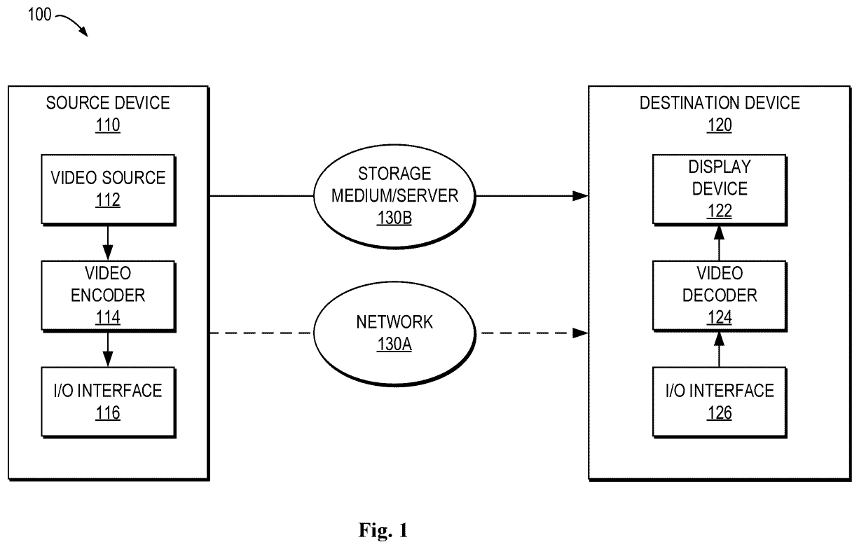

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

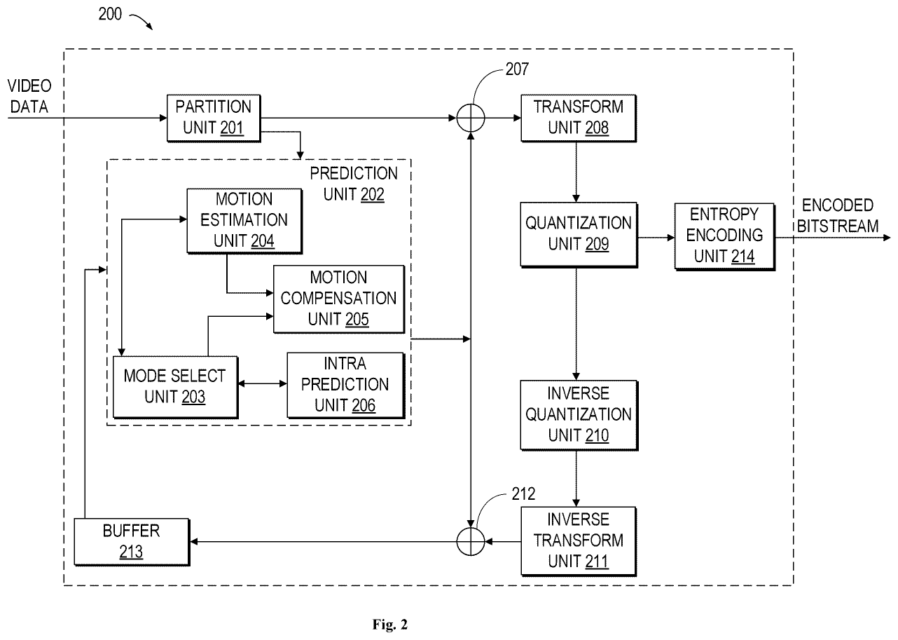

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

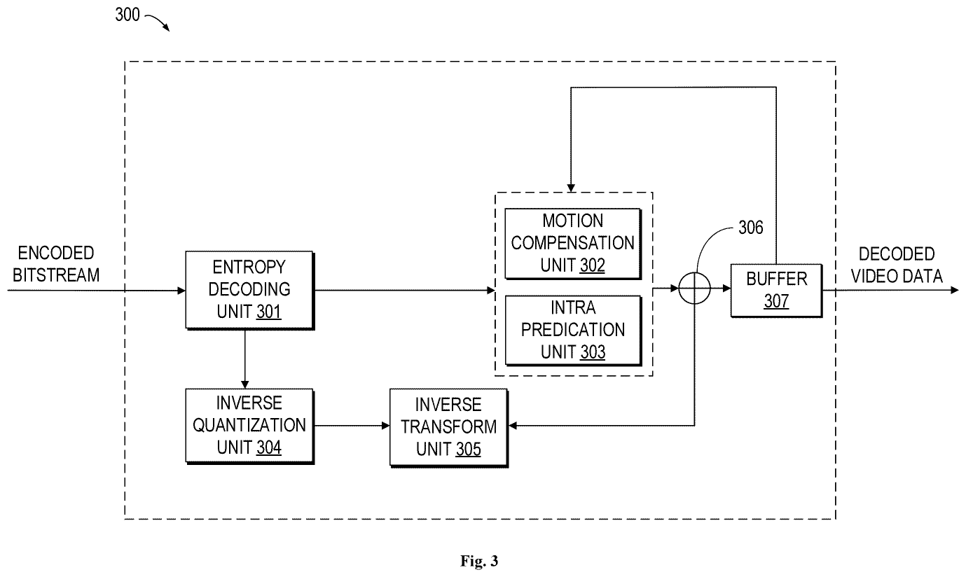

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

The present disclosure is related to video coding technologies. Specifically, it is related to intra block copy (IBC), how to and/or whether to combine IBC with local illumination compensation, and other coding tools in image/video coding. It may be applied to the existing video coding standard like HEVC, or Versatile Video Coding (VVC). It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC.

### 2.1 Coding Flow of a Typical Video Codec

FIG. 4 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

2.2 Intra Mode Coding with 67 Intra Prediction Modes

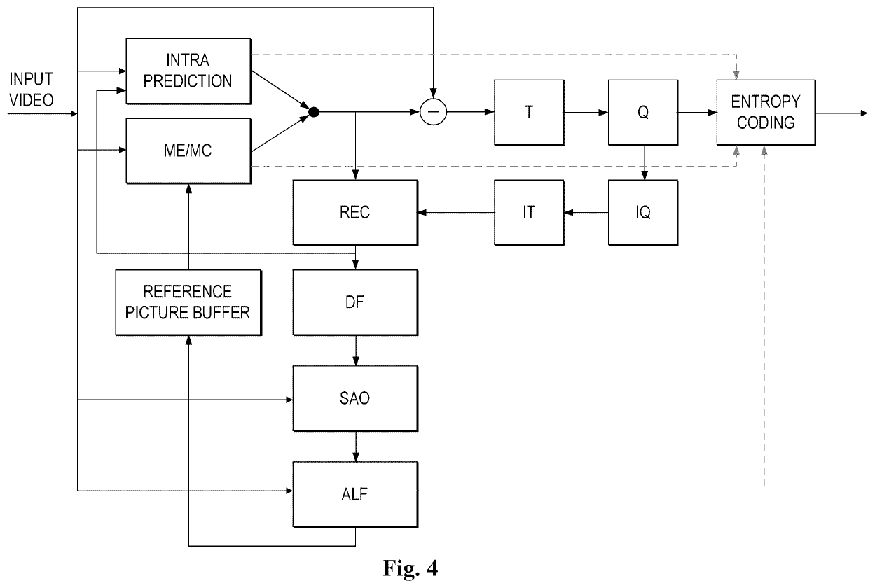

FIG. 5 illustrates 67 intra prediction modes. To capture the arbitrary edge directions presented in natural video, the number of directional intra modes is extended from 33, as used in HEVC, to 65, as shown in FIG. 5, and the planar and DC modes remain the same. These denser directional intra prediction modes apply for all block sizes and for both luma and chroma intra predictions.

In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.2.1 Wide Angle Intra Prediction

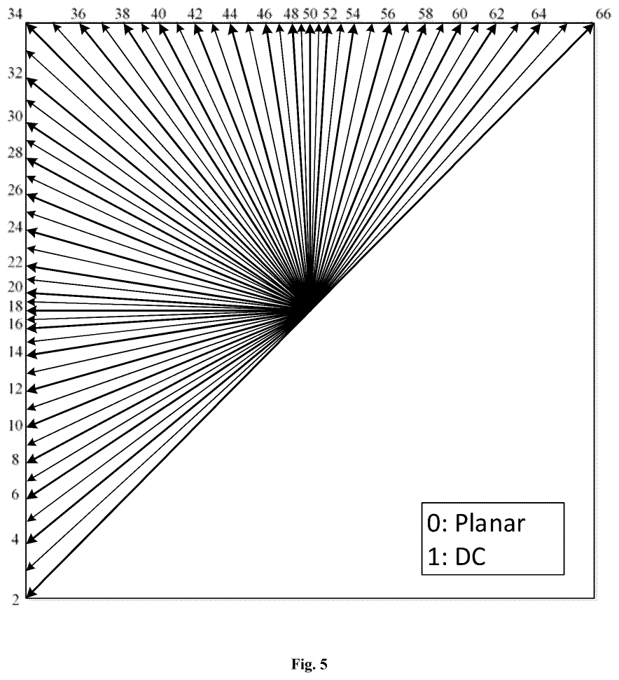

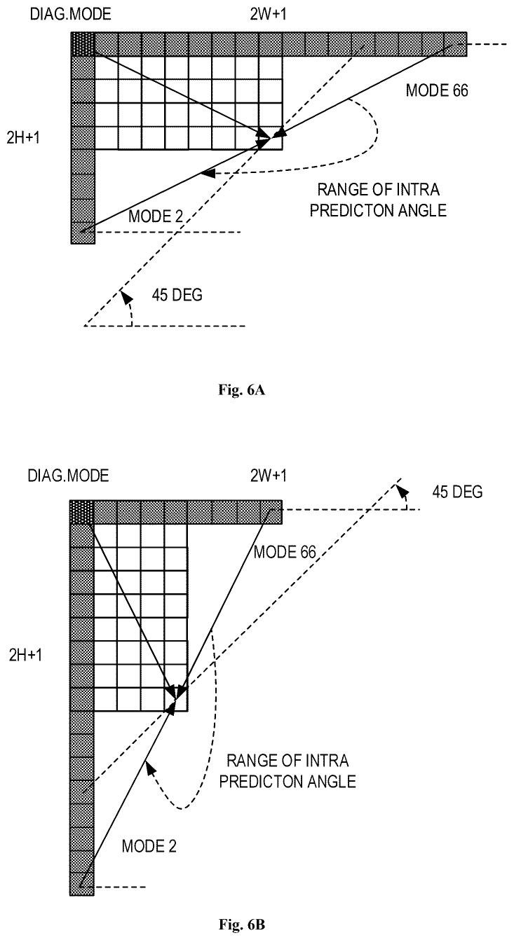

Although 67 modes are defined in the VVC, the exact prediction direction for a given intra prediction mode index is further dependent on the block shape. Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged. FIG. 6A and FIG. 6B illustrate reference samples for wide-angular intra prediction To support these prediction directions, the top reference with length 2W+1, and the left reference with length 2H+1, are defined as shown in FIG. 6A and FIG. 6B. FIG. 6A and FIG. 6B illustrate reference samples for wide-angular intra prediction. The number of replaced modes in wide-angular direction mode depends on the aspect ratio of a block. The replaced intra prediction modes are illustrated in Table 1.

TABLE 1
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, 65, 66 |

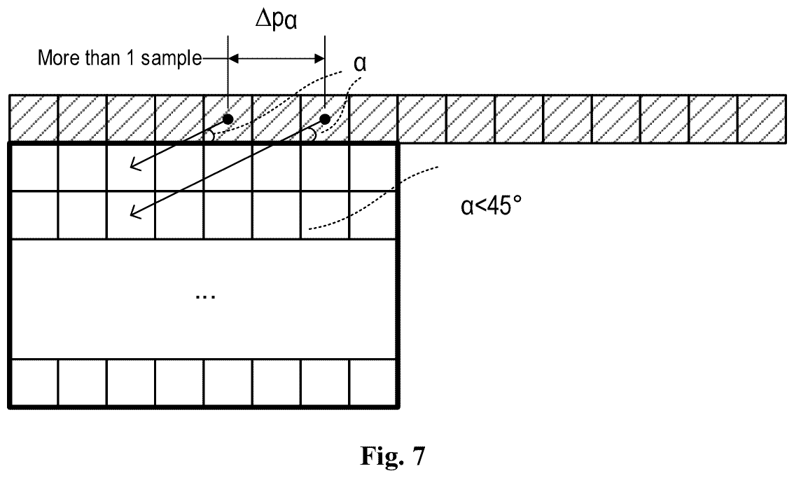

As shown in FIG. 7, two vertically adjacent predicted samples may use two non-adjacent reference samples in the case of wide-angle intra prediction. Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### 2.3 Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

### 2.4 Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signalled as IBC AMVP mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.
   2.5 Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.

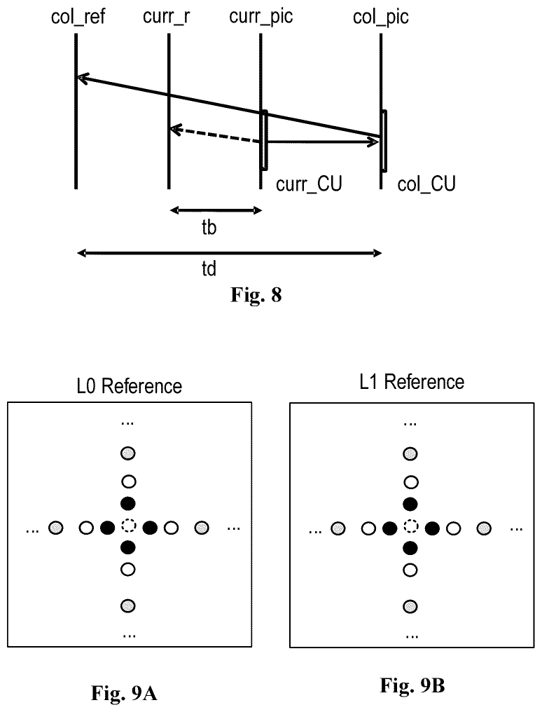

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates. FIG. 8 shows an illustration of motion vector scaling for temporal merge candidate.

FIG. 9A and FIG. 9B illustrate examples of MMVD search point. Distance index specifies motion magnitude information and indicate the pre-defined offset from the starting point. As shown in FIG. 9A and FIG. 9B, an offset is added to either horizontal component or vertical component of starting MV. The relation of distance index and pre-defined offset is specified in Table 2.

TABLE 2
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 3. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 3 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign in Table 3 specifies the sign of MV offset added to the list0 MV component of starting MV and the sign for the list1 MV has opposite value. Otherwise, if the difference of POC in list 1 is greater than list 0, the sign in Table 3 specifies the sign of MV offset added to the list1 MV component of starting MV and the sign for the list0 MV has opposite value.

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb, described in FIG. 8. If the POC difference of L1 is greater than L0, the MVD for list 0 is scaled in the same way. If the starting MV is uni-predicted, the MVD is added to the available MV.

TABLE 3
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 2.6 Local Illumination Compensation (LIC)

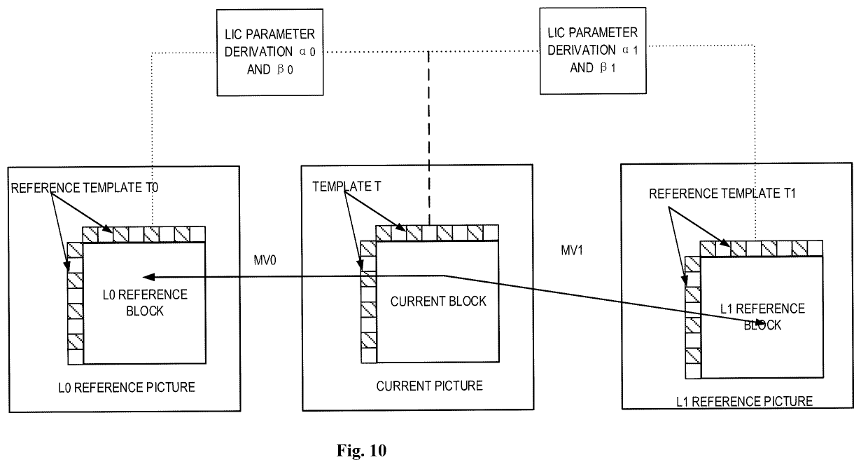

Local illumination compensation (LIC) is a coding tool to address the issue of local illumination changes between current picture and its temporal reference pictures. The LIC is based on a linear model where a scaling factor and an offset are applied to the reference samples to obtain the prediction samples of a current block. Specifically, the LIC can be mathematically modeled by the following equation:

$$P ( x , y ) = α \cdot {P}_{r} ( x + {v}_{x} , y + {v}_{y} ) + β$$

where P(x, y) is the prediction signal of the current block at the coordinate (x, y); Pᵣ(x+vₓ, y+v_{y}) is the reference block pointed by the motion vector (vₓ, v_{y}); α and β are the corresponding scaling factor and offset that are applied to the reference block. FIG. 10 illustrates the LIC process. FIG. 10 illustrates an example of local illustration compensation. In FIG. 10, when the LIC is applied for a block, a least mean square error (LMSE) method is employed to derive the values of the LIC parameters (i.e., α and β) by minimizing the difference between the neighboring samples of the current block (i.e., the template T in FIG. 10) and their corresponding reference samples in the temporal reference pictures (i.e., either T0 or T1 in FIG. 10). Additionally, to reduce the computational complexity, both the template samples and the reference template samples are subsampled (adaptive subsampling) to derive the LIC parameters, i.e., only the shaded samples in FIG. 10 are used to derive α and β.

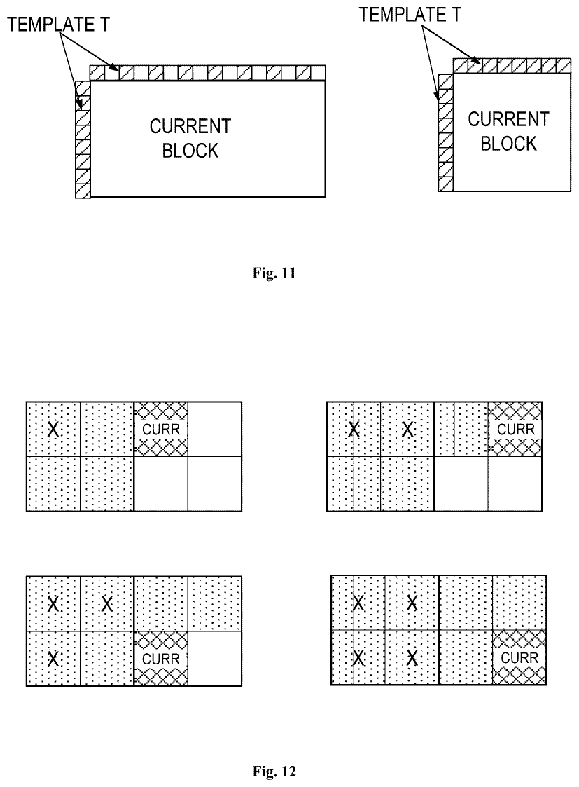

FIG. 11 illustrates no subsampling for the short side. To improve the coding performance, no subsampling for the short side is performed as shown in FIG. 11.

2.7 IBC with Template Matching

It is proposed to also use Template Matching with IBC for both IBC merge mode and IBC AMVP mode.

The IBC-TM merge list has been modified compared to the one used by regular IBC merge mode such that the candidates are selected according to a pruning method with a motion distance between the candidates as in the regular TM merge mode. The ending zero motion fulfillment (which is a nonsense regarding Intra coding) has been replaced by motion vectors to the left (−W, 0), top (0, −H) and top-left (−W, −H) CUs, then, if necessary, the list is fulfilled with the left one without pruning.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC merge list. Each of those 3 selected candidates are refined using the Template Matching method and sorted according to their resulting Template Matching cost. Only the 2 first ones are then considered in the motion estimation process as usual.

FIG. 12 illustrates IBC reference region depending on current CU position. The Template Matching refinement for both IBC-TM merge and AMVP modes is quite simple since IBC motion vectors are constrained to be integer and within a reference region as shown in FIG. 12. So, in IBC-TM merge mode, all refinements are performed at integer precision, and in IBC-TM AMVP mode, they are performed either at integer or 4-pel precision. In both cases, the refined motion vectors in each refinement step must respect the constraint of the reference region.

2.8 IBC Merge Mode with Block Vector Differences

IBC merge mode with block vector differences is shown as follows.

The distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding.

### 2.9 Reconstruction-Reordered IBC (RR-IBC)

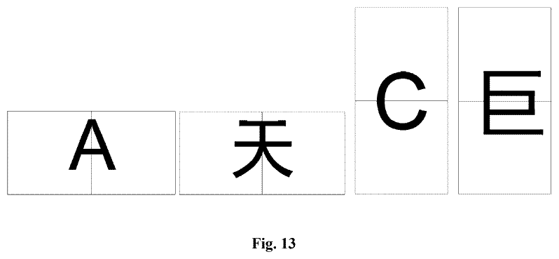

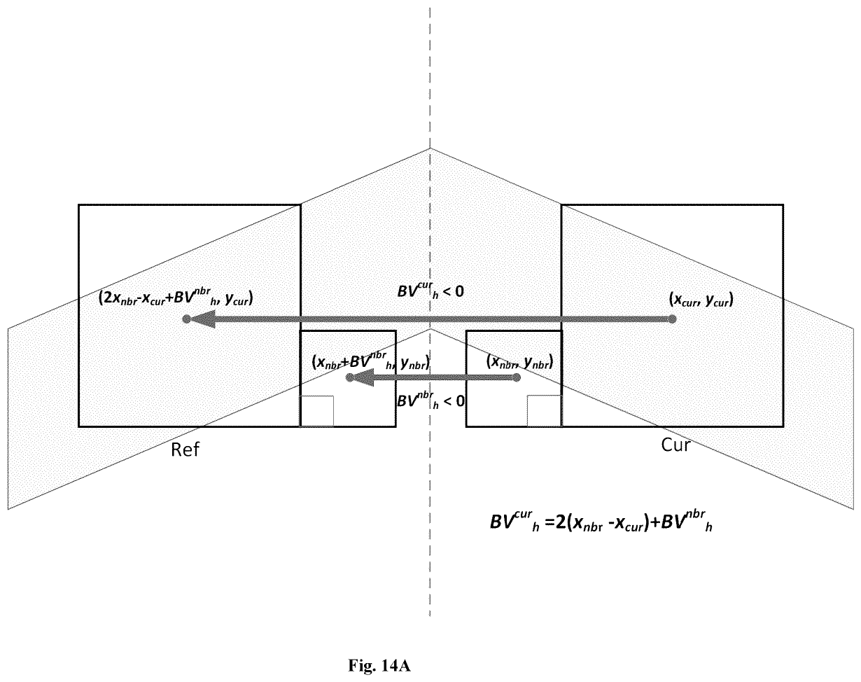

Screen content coding tools like Intra Block Copy (IBC) generate a prediction block by directly copying a prior coded reference region in the same picture. FIG. 13 illustrates examples of symmetry in screen content pictures. Symmetry is often observed in video content, especially in text character regions and computer-generated graphics in screen content sequences, as shown in FIG. 13. Therefore, a specific screen content coding tool considering the symmetry would be efficient to compress such kinds of video contents.

A Reconstruction-Reordered IBC (RR-IBC) mode is proposed for screen content video coding. When it is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

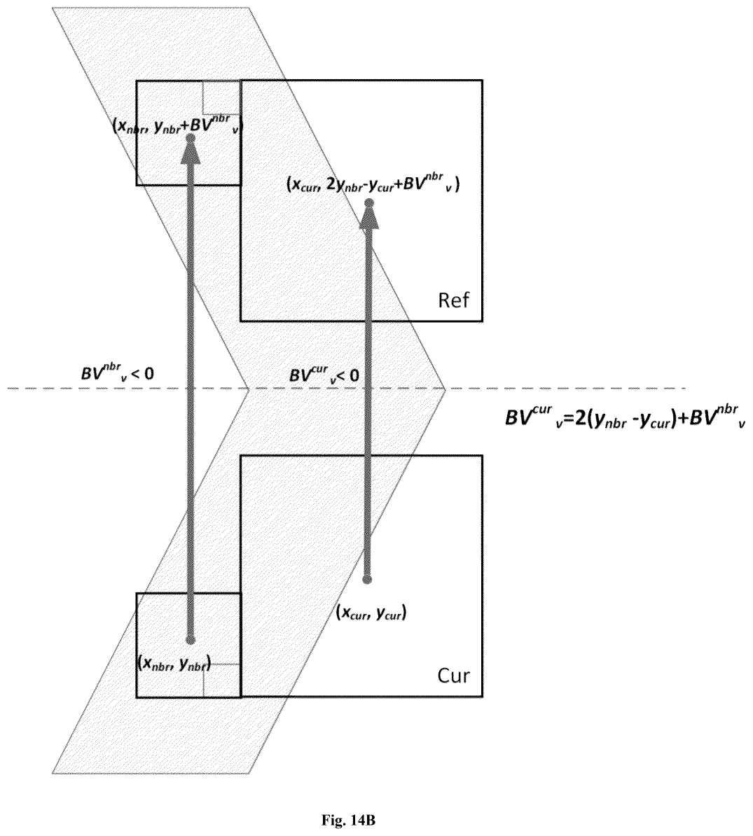

FIG. 14A illustrates an illustration of BV adjustment for horizontal flip. FIG. 14B illustrates an illustration of BV adjustment for vertical flip. To better utilize the symmetry property, a flip-aware BV adjustment approach is applied to refine the block vector candidate. For example, as shown in FIG. 14A and FIG. 14B, (x_{nbr}, y_{nbr}) and (x_{cur}, y_{cur}) represent the coordinates of the center sample of the neighboring block and the current block, respectively, BV^{nbr} and BV^{cur} denotes the BV of the neighboring block and the current block, respectively. Instead of directly inheriting the BV from a neighbouring block, the horizontal component of BV^{cur} is calculated by adding a motion shift to the horizontal component of BV^{nbr} (denoted as BV^{nbr}ₕ) in case that the neighbouring block is coded with a horizontal flip, i.e., BV^{cur}ₕ=2(x_{nbr}−x_{cur})+BV^{nbr}ₕ. Similarly, the vertical component of BV^{cur} is calculated by adding a motion shift to the vertical component of BV^{nbr} (denoted as BV^{nbr}ᵥ) in case that the neighbouring block is coded with a vertical flip, i.e., BV^{cur}ᵥ=2(y_{nbr}−y_{cur})+BV^{nbr}ᵥ.

### 2.10 Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

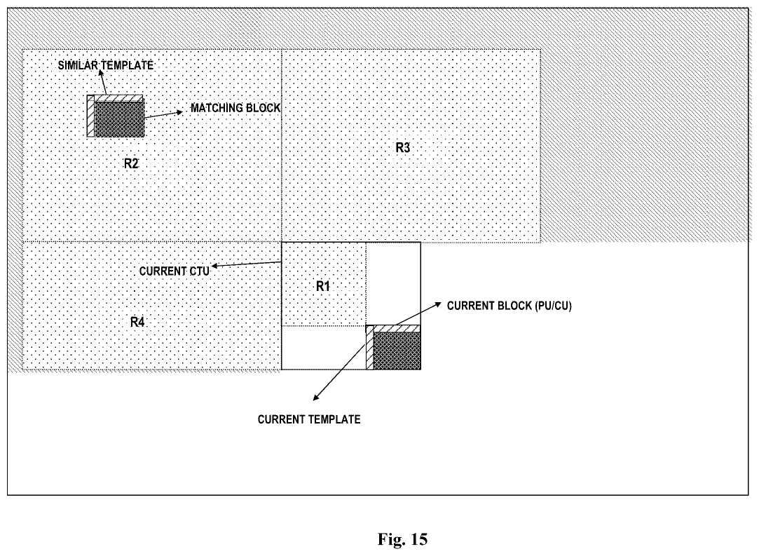

FIG. 15 illustrates an intra template matching search area used. The prediction signal is generated by matching the L-shaped causal neighbor of the current block with another block in a predefined search area in FIG. 15 consisting of:
R1: current CTU,
R2: top-left CTU,
R3: above CTU,
R4: left CTU.

SAD is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:
SearchRange_w=a*BlkW
SearchRange_h=a*BlkH
   where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### 3. Problems

In current design of IBC, the whole block is directly copied from the reconstructed region in the current picture. However, when illumination change occurs within the current picture, the coding efficiency of IBC may be limited.

### 4. Detailed Solutions

The detailed embodiments below should be considered as examples to explain general concepts. These embodiments should not be interpreted in a narrow way. Furthermore, these embodiments can be combined in any manner.

In the present disclosure, intra block copy (IBC) may not be limited to the current IBC technology, but may be interpreted as the technology that reference (or prediction) block is obtained with samples in the current slice/tile/subpicture/picture/other video unit (e.g., CTU row) excluding the conventional intra prediction methods. In the present disclosure, local illumination compensation (LIC) may not be limited to the current LIC technology. LIC may refer to an inter prediction technique to model local illumination variation between current block and its prediction block as a function of that between current block template and reference block template. The parameters of the function may be denoted by a linear equation (e.g., α×p[x]+β) or a non-linear equation.

In the present disclosure, CIBCIP (or IBC-CIIP) may refer to a coding tool which combines of intra block copy (IBC) and intra prediction. It's a coding tool which obtain the prediction of a block using both IBC and intra prediction.

In the present disclosure, IBC-GPM may refer to a coding tool which obtains the prediction of at least one sub-partitions using IBC in a video unit when the video unit is divided into more than one sub-partitions geometrically. In the following discussion, IBC may be replaced by other coding tools that rely on coded/decoded/reconstructed information within the same region, e.g., palette, intra template matching.

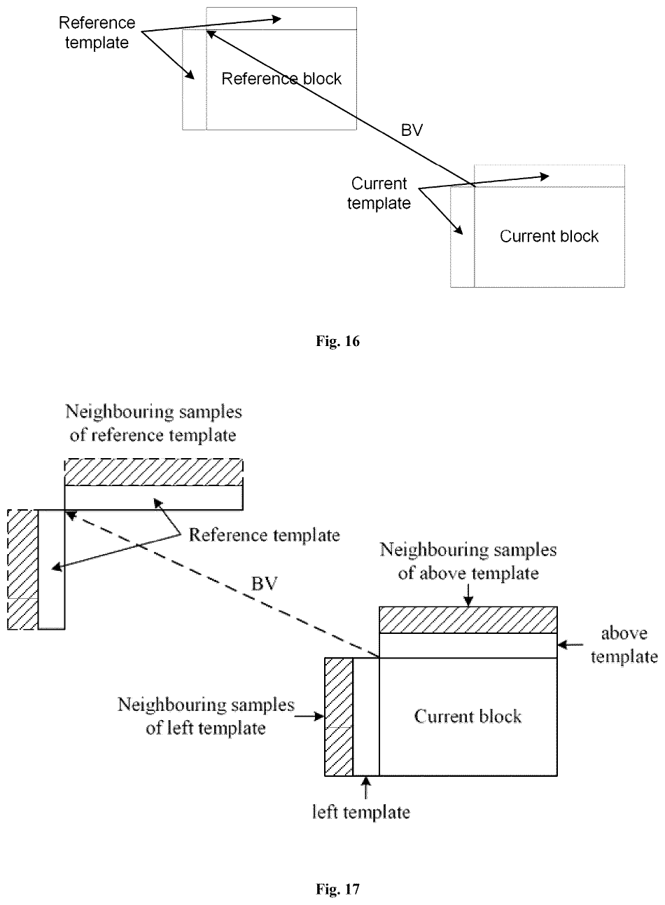

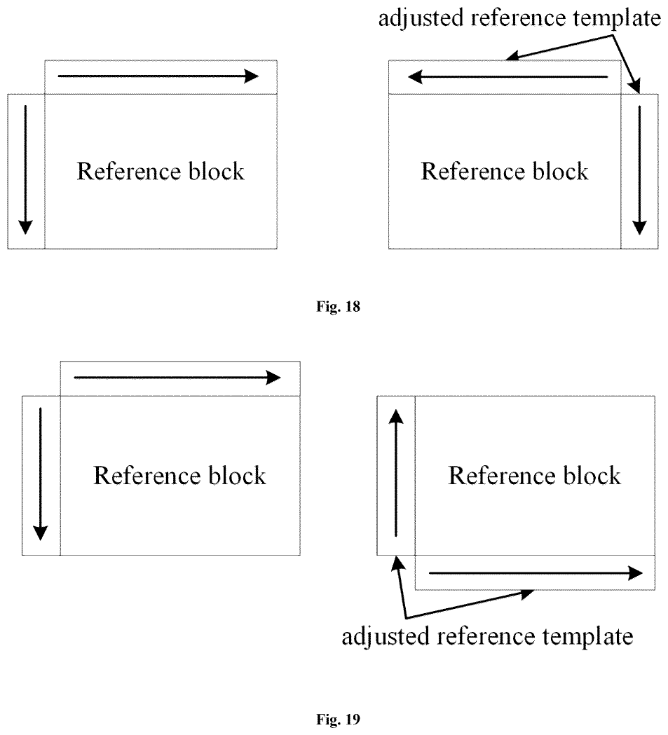

IBC with LIC
1. It is proposed that a refined prediction sample may be derived as f(p[x]), wherein p[x] denotes a prediction sample of the video unit, and f is any function.
a. In one example, f(p[x])=α×p[x]+β, wherein α and β denotes the parameters of the linear equation.
b. In one example, the function or at least one parameter of the function may be derived based on a template of the current block.
c. In one example, the prediction sample may be derived by IBC.
   i. In one example, the function or at least one parameter of the function may be derived based on a template of the reference block of the current block, wherein the reference block may be located by a block vector (BV).
      2. It is proposed that LIC may be applied to compensate the prediction (reconstruction) of a video unit, wherein IBC is used to obtain the prediction (reconstruction) of the video unit. It is denoted as IBC-LIC.
a. In one example, a linear or non-linear equation/model may be used for IBC-LIC to compensate the prediction of the video unit.
   i. In one example, the linear equation may be α×p[x]+β, wherein p[x] denotes the prediction of the video unit, and α and β denotes the parameters of the linear equation.
b. In one example, the parameters of the equation used in IBC-LIC may be pre-defined, or signalled in the bitstream.
c. In one example, the parameters of the equation used in IBC-LIC may be derived using coding information.
   i. In one example, a current template consists of the neighbouring reconstructed (adjacent or non-adjacent) samples of the video unit and a reference template may be used to derive the parameters. An example is shown in FIG. 16.
      1) In one example, the reference template may be derived using the BV that is used to obtain the prediction of the video unit.
      2) In one example, partial or all samples of the current template and the reference template may be used to derive the parameters.
      3) In one example, a least square error method may be used to derive the parameters.
   ii. In one example, how to derive the parameters using the current template and the reference template may be same as LIC for inter prediction.
d. In one example, partial or all prediction samples of the video unit may be compensated using IBC-LIC.
   3. In one example, IBC-LIC may be applied to IBC AMVP mode and/or IBC merge mode.
a. In one example, IBC AMVP mode may refer to normal IBC AMVP, or TM based IBC AMVP, or RR-IBC AMVP mode, or CIBCIP (IBC-CIIP), or IBC-GPM, or other IBC AMVP mode wherein a BV predictor is derived and BVD is signalled/derived.
b. In one example, IBC merge mode may refer to normal IBC merge mode, or IBC-TM merge mode, or IBC-MBVD mode, or CIBCIP (IBC-CIIP), or IBC-GPM.
   i. In one example, IBC-LIC may be applied to a specific IBC merge candidate type.
   ii. In another example, IBC-LIC may be not allowed to apply to a specific IBC merge candidate type.
      1) In one example, the merge candidate type may refer to RR-IBC candidate.
c. Alternatively, IBC-LIC may be not allowed to be applied to one or more of the above IBC coding tools.
   i. In one example, the IBC coding tool may refer to RR-IBC, or CIBCIP (IBC-CIIP), or IBC-GPM.
d. In one example, whether to and/or how to apply IBC-LIC for IBC AMVP mode and/or IBC merge mode may be signalled or determined using coding information.
e. In one example, one or more syntax elements may be signalled to indicate whether to and/or how to apply IBC-LIC for IBC AMVP mode and/or IBC merge mode.
f. In one example, whether to and/or how to apply IBC-LIC for IBC merge mode may be inherited.
   i. In one example, the inheritance of whether to and/or how to apply IBC-LIC may be associated with the merge candidate.
      1) In one example, IBC-LIC may be disabled when a merge candidate is a specific merge type.
         a) In one example, the specific type may refer to RR-IBC.
   ii. In one example, whether to apply IBC-LIC for IBC merge mode may be derived.
      1) In one example, template matching based method may be used.
         a) In one example, a first cost (C₁) may be calculated between the prediction of the template of current video unit and its reconstruction when IBC-LIC is applied; a second cost (C₂) may be calculated between the prediction of the template of current video unit and its reconstruction when IBC-LIC is not applied.
         i. In one example, when C₁<=C₂, IBC-LIC may be applied; when C₁>C₂, IBC-LIC may be not applied.
         ii. In one example, when C₁<=S*C₂, IBC-LIC may be applied; when C₁>S*C₂, IBC-LIC may be not applied, wherein S is a scale factor.
         iii. In one example, when C₁<=C₂+O, IBC-LIC may be applied; when C₁>C₂+O, IBC-LIC may be not applied, wherein O is an offset.
            4. In one example, IBC-LIC may be used in the process of reordering a BV candidate list.
a. In one example, the BV candidate list may refer to IBC AMVP candidate list, and/or IBC merge candidate list.
   i. In one example, the BV candidate list may refer to IBC regular merge list, and/or IBC TM merge list, and/or IBC-MBVD merge list.
b. In one example, whether to and/or how to apply IBC-LIC in the BV candidate list reordering process may be same as that applying IBC-LIC to the current video unit.
c. In one example, when IBC-LIC is used for a BV candidate, the prediction of the template may be refined using the IBC-LIC model.
   i. In one example, the neighbouring reconstructed samples of the left/above template, and/or the neighbouring reconstructed samples of the reference template of the left/above template may be used to derive the IBC-LIC parameters. An example is shown in FIG. 17.
      1) In one example, the reference template of the left/above template may be derived using the BV associated with the BV candidate.
      2) In one example, the neighbouring reconstructed samples of the left/above template, and/or the neighbouring reconstructed samples of the reference template of the left/above template, and/or the left/above template may be constrained in the IBC buffer.
      3) In one example, when the neighbouring reconstructed samples of the left/above template, and/or the neighbouring reconstructed samples of the reference template of the left/above template, and/or the left/above template are out of the IBC buffer, IBC-LIC may be not used.
         a) Alternatively, when the neighbouring reconstructed samples of the left/above template, and/or the neighbouring reconstructed samples of the reference template of the left/above template, and/or the left/above template are out of the IBC buffer, the samples out of the IBC buffer may be padded using the samples in the IBC buffer and IBC-LIC may be used.
d. In one example, IBC-LIC may be applied to one or more BV candidates in the BV candidate list.
   i. In one example, whether to apply IBC-LIC to a BV candidate may depend on the type of the BV candidate.
      1) In one example, the type of the BV candidate may refer to spatial BV candidate, or HMVP BV candidate, or pairwise BV candidate, or default BV candidate, or other types of BV candidate.
e. In one example, when a BV candidate is RR-IBC (e.g., RR-IBC flip type is horizontal or vertical), IBC-LIC may be not used.
   i. Alternatively, IBC-LIC may be used.
      1) In one example, the original BV of the BV candidate may be used to derive the IBC-LIC parameters.
      2) In one example, the adjusted BV of the BV candidate according to the RR-IBC flip type may be used to derive the IBC-LIC parameters.
f. In one example, a set of IBC-LIC parameters may be derived.
   i. In one example, the derived set of IBC-LIC parameters may be used for left and/or above template.
g. In one example, multiple sets of IBC-LIC parameters may be derived.
   i. In one example, a first set of IBC-LIC parameters may be used for the left template.
   ii. In one example, a second set of IBC-LIC parameters may be used for the above template.
h. In one example, whether to and/or how to apply IBC-LIC to the BV candidate list reordering may depend on a specific coding tool using the BV candidate list.
   i. In one example, IBC-LIC may be applied to the BV candidate list reordering when the coding tool is IBC AMVP mode, and/or IBC regular merge mode, and/or IBC TM merge mode, and/or IBC-MBVD merge mode.
   ii. Alternatively, IBC-LIC may be not applied to the BV candidate list reordering when the coding tool is IBC AMVP mode, and/or IBC regular merge mode, and/or IBC TM merge mode, and/or IBC-MBVD merge mode.
      5. In one example, when RR-IBC is used, IBC-LIC may be used.
a. In one example, the positions/shapes/of a template used for LIC may depend on whether RR-IBC is applied.
b. In one example, the original BV without adjusted according to the RR-IBC flip type may be used to derive the IBC-LIC parameters.
c. In one example, the adjusted BV according to the RR-IBC flip type may be used to derive the IBC-LIC parameters.
d. In one example, the original template of the reference block may be used to derive the IBC-LIC parameters.
   i. In one example, the original template of the reference block may be constrained in the IBC buffer.
   ii. In one example, when the original template is not in the IBC buffer, IBC-LIC may be not used.
      1) Alternatively, when the original template is not in the IBC buffer, the original template may be padded using the samples in the IBC buffer and then used in IBC-LIC.
e. In one example, the adjusted template of the reference block may be used to derive the IBC-LIC parameters.
   i. In one example, the adjusted template of the reference block may be constrained in the IBC buffer.
   ii. In one example, the adjusted template of the reference block may be adjusted according to the RR-IBC flip type.
      1) In one example, when RR-IBC flip type is horizontal, the adjusted left and above template of the reference template may be used. An example is shown in FIG. 18.
      2) In one example, when RR-IBC flip type is vertical, the adjusted left and above template of the reference template may be used. An example is shown in FIG. 19.
   iii. In one example, when the adjusted template is not in the IBC buffer, IBC-LIC may be not used.
      1) Alternatively, when the adjusted template is not in the IBC buffer, the adjusted template may be padded using the samples in the IBC buffer and then used in IBC-LIC.
f. In one example, IBC-LIC may be used with a specific RR-IBC flip type.
   i. In one example, the flip type may be horizontal.
   ii. In one example, the flip type may be vertical.
      6. In one example, whether to and/or how to apply IBC-LIC may depend on the coding information including:
a. block dimensions and/or block size
   i. In one example, the block is allowed to be coded with IBC-LIC when the block size (W×H) is less than or equal to a threshold (T1), wherein W and H denotes block width and block height, respectively.
      1) In one example, T1=256, or 512, or 1024, or 2048, or 4096.
      2) In one example, T1 may depend on whether IBC AMVP mode or IBC merge mode is used.
      3) In one example, TI may depend on slice/picture type.
   ii. In one example, the block is allowed to be coded with IBC-LIC when the block size (W×H) is larger than or equal to a threshold (T2), wherein W and H denotes block width and block height, respectively.
      1) In one example, T2=16, or 32, or 64, or 128, or 256.
      2) In one example, T2 may depend on whether IBC AMVP mode or IBC merge mode is used.
      3) In one example, T2 may depend on slice/picture type.
   iii. In one example, the block size may refer to luma block size.
b. the coded information may refer to the depth of a block.
c. slice/picture type and/or partition tree type (single, or dual tree, or local dual tree)
   i. In one example, IBC-LIC may be only applied to I slice/picture.
d. block location
e. quantization parameter
f. colour component.
   7. In one example, more than one LIC equations may be used to compensate the prediction (reconstruction) of a video unit which is derived using IBC.
a. In one example, the multiple LIC types may refer to different LIC equations with adjustment parameters for one or more existing parameters of LIC (e.g., α and β).
   i. In one example, an adjustment parameter may be used to adjust α, such as α+u or α×u.
   ii. In one example, an adjustment parameter may be used to adjust β, such as β+v or β×v.
b. In one example, the parameters of more than one LIC equations may be derived using different templates.
   i. In one example, different sample lines of the template may be used.
   ii. In one example, left, or above, or left-above templates may be used.
   iii. In one example, samples from different positions in the template may be used.
      1) In one example, the positions may refer to down-sampling positions.
   iv. In one example, samples in different categories may be used.
      1) In one example, the different categories may be classified depending on the samples of the template.
      2) In one example, a mean value of the samples in the template may be used to derive the different categories.
c. In one example, whether to and how to apply one of the more than one LIC equations may be indicated using a syntax element which is signalled in the bitstream.
d. In one example, whether to and how to apply one of the more than one LIC equations may be determined adaptively.
   8. In one example, the positions/shape of the template may depend on coding information.
a. In one example, if the left neighboring samples are unavailable, the template only contains the above neighbouring samples.
b. In one example, if the above neighboring samples are unavailable, the template only contains the left neighbouring samples.
c. In one example, if the left and above neighboring samples are unavailable, IBC-LIC may not be applicable.
d. In one example, the template may refer to the template of the current block or the reference block.
e. In one example, the positions/shape of the template may depend on whether RR-IBC or normal IBC is applied.
f. In one example, the positions/shape of the template may consist of one or more sample lines.
g. In one example, the positions/shape of the template may be pre-defined, or signalled, or derived on-the-fly.
h. In one example, the positions/shape of the template may depend on the width and height of the video unit.
i. In one example, the reference template may be constrained in the IBC buffer.
   i. Alternatively, the reference template may be not constrained in the IBC buffer.
      9. The determination of whether a block is allowed to be coded with IBC-LIC mode may depend on coded information including:
a. block dimensions and/or block size.
   i. In one example, the block is allowed to be coded with IBC-LIC mode when the block size (W×H) is less than or equal to a threshold (T), wherein W and H denotes block width and block height, respectively.
      1) In one example, T=256, or 512, or 1024, or 2048, or 4096.
b. depth of a block.
c. block location.
d. slice/picture type.
e. temporal layer (e.g., temporal layer index).
f. colour format.
g. colour component.
   10. In one example, whether to and/or how to apply IBC-LIC may depend on colour format and/or colour components.
a. In one example, IBC-LIC may apply to all colour components.
b. In one example, whether to and/or how to apply IBC-LIC to a first component may depend on whether to apply IBC-LIC to a second component.
   i. In one example, the first component may refer to chroma component (e.g., Cb and/or Cr), and the second component may refer to luma component (e.g., Y).
   ii. In one example, the way to apply IBC-LIC to the first component may be same as the second component.
      1) Alternatively, the way to apply IBC-LIC to the first component may be different from the second component.
c. In one example, IBC-LIC may apply to luma component, but not to chroma components.
   i. In one example, luma component may refer to Y in YCbCr colour space or G in RGB colour space.
   ii. In one example, chroma components may refer to Cb and/or Cr in YCbCr colour space or R and/or B in RGB colour space.

### On Signalling of IBC-LIC

11. Indication of the IBC-LIC mode may be conditionally signalled wherein the condition may include:
a. whether a specific coding method is allowed, such as IBC (IBC AMVP or IBC merge), or RR-IBC, or CIBCIP (IBC-CIIP), or IBC-TM, or IBC-GPM
b. block dimensions and/or block size
   i. In one example, the indication of the IBC-LIC mode may be not signalled when the block size (W×H) is less than or equal to a threshold (T3), wherein W and H denotes block width and block height, respectively.
      1) In one example, T3=256, or 512, or 1024, or 2048, or 4096.
      2) In one example, T3 may depend on whether IBC AMVP mode or IBC merge mode is used.
      3) In one example, T3 may depend on slice/picture type.
   ii. In one example, the indication of the IBC-LIC mode may be not signalled when the block size (W×H) is larger than or equal to a threshold (T4), wherein W and H denotes block width and block height, respectively.
      1) In one example, T4 =16, or 32, or 64, or 128, or 256.
      2) In one example, T4 may depend on whether IBC AMVP mode or IBC merge mode is used.
      3) In one example, T4 may depend on slice/picture type.
   iii. In one example, the block size may refer to luma block size.
c. block depth
d. slice/picture type and/or partition tree type (single, or dual tree, or local dual tree)
e. temporal layer identification
f. block location
g. colour component
h. In one example, the indication of the IBC-LIC mode may be not signalled but derived.
i. In one example, if the indication of the IBC-LIC mode is not signalled, it may be inferred to be a default value.
   i. In one example, if the indication of the IBC-LIC mode is not signalled, it may be inferred to be false.
   ii. In one example, if the indication of the IBC-LIC mode is not signalled, it may be inferred to be true.
      12. Whether current block is coded with IBC-LIC mode may be signalled using one or more syntax elements.
a. In one example, the syntax element may be binarized with fixed length coding, or truncated unary coding, or unary coding, or EG coding, or coded a flag.
b. In one example, the syntax element may be bypass coded or context coded.
   i. The context may depend on coded information, such as block dimensions, and/or block size, and/or slice/picture types, and/or the information of neighbouring blocks (adjacent or non-adjacent), and/or the information of other coding tools used for current block, and/or the information of temporal layer.
      1) In one example, the context may depend on whether the neighbouring blocks are coded with IBC-LIC.
c. In one example, the indication of IBC-LIC mode may be signalled when current video unit is IBC coded.
d. In one example, the indication of IBC-LIC mode may be not signalled when current video unit is IBC merge mode.
e. In one example, the syntax element may be signalled before or after the indication of a specific coding tool.
   i. In one example, the specific coding tool may refer to RR-IBC mode, or IBC-TM mode, or IBC-MBVD mode, or CIBCIP (IBC-CIIP), or IBC-GPM.
   ii. In one example, whether to signal and/or how to the syntax element may be dependent on whether IBC mode, RR-IBC mode, or IBC-TM mode, or IBC-MBVD mode, or CIBCIP (IBC-CIIP), or IBC-GPM is enabled for the video unit.
   iii. In one example, the syntax element may be signalled after the indication of RR-IBC mode.
      1) In one example, when RR-IBC mode is applied, the syntax element indicating IBC-LIC is not signalled and set to a default value which indicates IBC-LIC is not applied.
   iv. In one example, the syntax element may be signalled when the video unit is IBC-AMVP mode.
f. In one example, the one or more syntax elements may be signalled at sequence header/picture header/SPS/VPS/DPS/DCI/PPS/APS/slice header/tile group header.
g. In one example, the syntax element may be coded in a predictive way.
h. For example, the syntax element of the current block may be predicted by that of a neighboring block.
i. In one example, whether a block is allowed to be coded with IBC-LIC mode may depend on one or more syntax elements.
   i. In one example, the one or more syntax elements may be signalled as general constraints information.
      1) In one example, when a syntax element (e.g., gci_no_ibc_lic_constraint_flag) indicating general constraint on IBC-LIC is equal to X1 (e.g., X1=0 or X1=1), IBC-LIC shall be not allowed.
      2) In one example, when either a syntax element (e.g., gci_no_ibc_constraint_flag) indicating general constraint on IBC is equal to X2 (e.g., X2=0 or X2=1), IBC-LIC shall be not allowed.
   ii. In one example, the one or more syntax elements may be signalled at sequence header/picture header/SPS/VPS/DPS/DCI/PPS/APS/slice header/tile group header.

### General Aspects

13. In above examples, the video unit may refer to the colour component/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/a block/sub-block of a block/sub-region within a block/any other region that contains more than one sample or pixel.
14. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
15. Whether to and/or how to apply the disclosed methods above may be signalled at PB/TB/CB/PU/TU/CU/VPDU/CTU/CTU row/slice/tile/sub-picture/other kinds of region contains more than one sample or pixel.
16. Whether to and/or how to apply the disclosed methods above may be dependent on coded information, such as block size, colour format, single/dual tree partitioning, colour component, slice/picture type.

### 5. Embodiment

### 5.1 Embodiment 1

In this contribution, three aspects are proposed to extend the use of IBC:
Aspect #1: Combined IBC and intra prediction (IBC-CIIP);
Aspect #2: IBC with geometry partitioning (IBC-GPM);
Aspect #3: IBC with local illumination compensation (IBC-LIC).

### Combined IBC and Intra Prediction (IBC-CIIP)

When IBC-CIIP is applied to a CU, two prediction signals are obtained using IBC and intra prediction. The two prediction signals weighted summed to generate the final prediction. IBC-CIIP can be applied to IBC AMVP mode and IBC merge mode. A CU flag is signalled to indicate the use of IBC-CIIP.

IBC with Geometry Partitioning (IBC-GPM)

When IBC-GPM is applied to a CU, the CU is divided into two sub-partitions geometrically. The prediction signals of the two sub-partitions are generated using IBC and intra prediction. IBC-GPM can be applied to IBC merge mode. A CU flag is signalled to indicate the use of IBC-GPM.

IBC with Local Illumination Compensation (IBC-LIC)

When IBC-LIC is applied to a CU, local illumination variation between the CU and its prediction block is modelled as a linear equation. The parameters of the linear equation are derived similar to LIC for inter prediction. IBC-LIC can be applied to IBC AMVP mode and IBC merge mode. For IBC AMVP mode, an IBC-LIC flag is signalled to indicate the use of IBC-LIC. For IBC merge mode, the IBC-LIC flag is inferred from the merge candidate.

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one ore multiple CTUs/CTBs, one or multiple Virtual Pipeline Data Unit (VPDU), a sub-region within a picture/slice/tile/brick. The term “reference line” may refer to a row and/or a column reconstructed samples adjacent to or non-adjacent to the current block, which is used to derive the intra prediction of current video unit via an interpolation filter along a certain direction, and the certain direction is determined by an intra prediction mode (e.g., conventional intra prediction with intra prediction modes), or derive the intra prediction of current video unit via weighting the reference samples of the reference line with a matrix or vector (e.g., MIP).

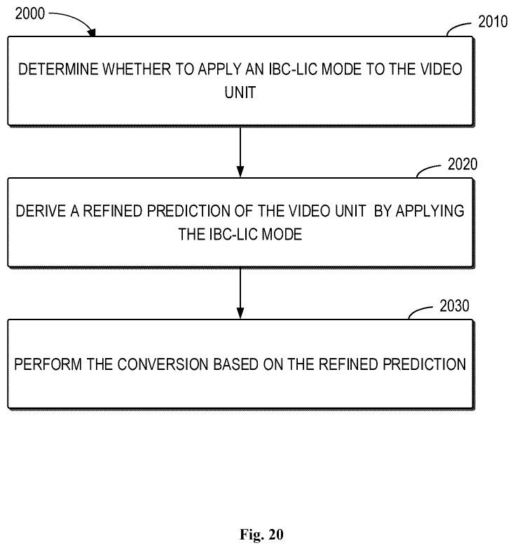

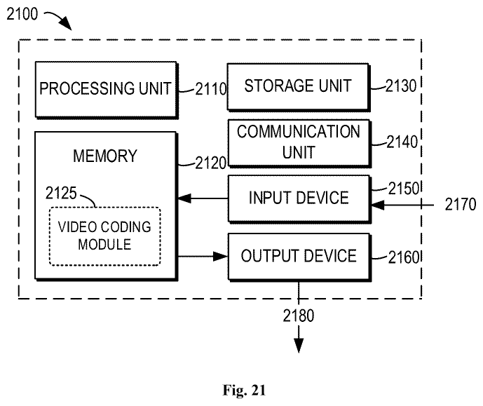

FIG. 20 illustrates a flowchart of a method 2000 for video processing in accordance with embodiments of the present disclosure. The method 2000 is implemented during a conversion between a video unit of a video and a bitstream of the video.

At block 2010, a prediction of the video unit is obtained by applying the IBC to the video unit.

At block 2020, the refined prediction of the video unit is obtained by applying the LIC to the prediction.

At block 2030, the conversion is performed based on the refined prediction sample. In some embodiments, the conversion may include encoding the video unit into the bitstream. Alternatively, or in addition, the conversion may include decoding the video unit from the bitstream. In this way, it can improve coding efficiency and coding performance.

In some embodiments, whether to apply the IBC-LIC mode for IBC merge mode is derived. In some embodiments, a template matching based approach is used to determine whether to apply the IBC-LIC mode for IBC merge mode.

In some embodiments, a first cost is calculated between the prediction of a template of the video unit and a reconstruction of the template when the IBC-LIC mode is applied, and a second cost is calculated between the prediction of the template of the video unit and a reconstruction of the template when the IBC-LIC mode is not applied. For example, a first cost (C₁) may be calculated between the prediction of the template of current video unit and its reconstruction when IBC-LIC is applied; a second cost (C₂) may be calculated between the prediction of the template of current video unit and its reconstruction when IBC-LIC is not applied.

In some embodiments, if the first cost is smaller than or equal to the second cost, the IBC-LIC mode is applied. Alternatively, or in addition, if the first cost is larger than the second cost, the IBC-LIC mode is not applied. In one example, when C₁<=C₂, IBC-LIC may be applied; when C₁>C₂, IBC-LIC may be not applied.

In some embodiments, if the first cost is smaller than or equal to the second cost multiplied with a scale factor, the IBC-LIC mode is applied. Alternatively, or in addition, if the first cost is larger than the second cost multiplied with the scale factor, the IBC-LIC mode is not applied. In one example, when C₁<=S*C₂, IBC-LIC may be applied; when C₁>S*C₂, IBC-LIC may be not applied, where S is a scale factor.

In some embodiments, if the first cost is smaller than or equal to a sum of the second cost and an

offset, the IBC-LIC mode is applied. Alternatively, or in addition, if the first cost is larger than the sum of the second cost and the offset, the IBC-LIC mode is not applied. In one example, when C₁<=C₂+O, IBC-LIC may be applied; when C₁>C₂+O, IBC-LIC may be not applied, where O is an offset.

In some embodiments, the IBC-LIC mode is used in a process of reordering a block vector (BV) candidate list. In some embodiments, the BV candidate list is at least one of: an IBC advanced motion vector prediction (AMVP) candidate list, or an IBC merge candidate list. In some embodiments, the BV candidate list is at least one of: an IBC regular merge list, an IBC template matching (TM) merge list, or an IBC-merge mode with block vector difference (MBVD) merge list. In some embodiments, whether to and/or an approach to apply the IBC-LIC mode in the process of reordering BV candidate list is same as that applying the IBC-LIC mode to the video unit.

In some embodiments, if the IBC-LIC mode is used for a BV candidate, the prediction of a template of the video unit is refined using the IBC-LIC mode. In some embodiments, at least one of: neighboring reconstructed samples of a left or above template, or neighboring reconstructed samples of a reference template of the left or above template is used to derive parameters of the IBC-LIC mode, for example, as shown in FIG. 17. In some embodiments, the reference template of the left or above template is derived using a BV associated with the BV candidate. In some embodiments, at least one of: the neighboring reconstructed samples of the left or above template, the neighboring reconstructed samples of the reference template of the left or above template, or the left or above template is constrained in an IBC buffer.

In some embodiments, if at least one of: the neighboring reconstructed samples of the left or above template, the neighboring reconstructed samples of the reference template of the left or above template, or the left or above template is out of an IBC buffer, the IBC-LIC mode is not used. In some other embodiments, if at least one of: the neighbouring reconstructed samples of the left or above template, the neighbouring reconstructed samples of the reference template of the left or above template, or the left or above template is out of an IBC buffer, samples out of the IBC buffer are padded using samples in the IBC buffer, and the IBC-LIC mode is used.

In some embodiments, the IBC-LIC mode is applied to one or more BV candidates in the BV candidate list. In some embodiments, whether to apply the IBC-LIC mode to a BV candidate depends on a type of the BV candidate. In some embodiments, the type of the BV candidate comprises one of: a spatial BV candidate, a history based motion vector prediction (HMVP) BV candidate, a pairwise BV candidate, a default BV candidate, or other types of BV candidate.

In some embodiments, if a BV candidate is a reconstruction-reordered IBC (RR-IBC), the IBC-LIC mode is not used. In one example, when a BV candidate is RR-IBC (e.g., RR-IBC flip type is horizontal or vertical), IBC-LIC may be not used. Alternatively, if a BV candidate is a RR-IBC, the IBC-LIC mode is used.

In some embodiments, an original BV of the BV candidate is used to derive IBC-LIC parameters. In some embodiments, an adjusted BV of the BV candidate according to a RR-IBC flip type is used to derive IBC-LIC parameters.

In some embodiments, a set of IBC-LIC parameters is derived. In some embodiments, the derived set of IBC-LIC parameters is used for at least one of: a left template or an above template.

In some embodiments, a plurality of sets of IBC-LIC parameters are derived. In some embodiments, a first set of IBC-LIC parameters in the plurality of sets of IBC-LIC parameters is used for the left template. Alternatively, or in addition, a second set of IBC-LIC parameters in the plurality of sets of IBC-LIC parameters is used for the above template.

In some embodiments, whether to and/or an approach to apply the IBC-LIC mode to the BV candidate list reordering depends on a coding tool using the BV candidate list. In some embodiments, the IBC-LIC mode is applied to the process of reordering the BV candidate list, if the coding tool is at least one of: an IBC AMVP mode, an IBC regular merge mode, an IBC TM merge mode, or an IBC-MBVD merge mode. In some other embodiments, the IBC-LIC mode is not applied to the process of reordering the BV candidate list, if the coding tool is at least one of: an IBC AMVP mode, an IBC regular merge mode, an IBC TM merge mode, or an IBC-MBVD merge mode.

In some embodiments, if RR-IBC is used, the IBC-LIC mode is used. In some embodiments, at least one of: positions or shapes of a template used for LIC depends on whether RR-IBC is applied.

In some embodiments, an original BV without adjusted according to a RR-IBC flip type is used to derive IBC-LIC parameters. In some embodiments, an adjusted BV according to the a-IBC flip type is used to derive IBC-LIC parameters.

In some embodiments, an original template of a reference block is used to derive IBC-LIC parameters. In some embodiments, the original template of the reference block is constrained in an IBC buffer. In some embodiments, if the original template is not in an IBC buffer, the IBC-LIC mode is not used. In some embodiments, if the original template is not in the IBC buffer, the original template is padded using samples in an IBC buffer and the padded original template is used in the IBC-LIC mode.

In some embodiments, an adjusted template of a reference block is used to derive IBC-LIC parameters. In some embodiments, the adjusted template of the reference block is constrained in an IBC buffer. In some embodiments, the adjusted template of the reference block is adjusted according to an RR-IBC flip type.

In some embodiments, if the RR-IBC flip type is horizontal, the adjusted left and above template of the reference template is used, for example, as shown in FIG. 18. In some embodiments, if the RR-IBC flip type is vertical, the adjusted left and above template of the reference template is used, for example, as shown in FIG. 19.

In some embodiments, if the adjusted template is not in an IBC buffer, the IBC-LIC mode is not used. In some embodiments, if the adjusted template is not in an IBC buffer, the adjusted template is padded using samples in the IBC buffer and then the padded template is used in the IBC-LIC mode.

In some embodiments, the IBC-LIC mode is used with a RR-IBC flip type. In some embodiments, the RR-IBC flip type is horizontal. Alternatively, the RR-IBC flip type is vertical.

In some embodiments, whether to and/or an approach to apply the IBC-LIC mode depends on coding information of the video unit, and where the coding information of the video unit comprises at least one of: a block dimension, a block size, a depth of the video unit, a slice type, a picture type, a partition tree type, a block location, a quantization parameter, or a colour component.

In some embodiments, a block is allowed to be coded with the IBC-LIC mode when a block size is less than or equal to a first threshold, where the block size is equal to W×H, and W and H denotes block width and block height of the block, respectively. In some embodiments, the first threshold is equal to one of: 256, 512, 1024, 2048 or 4096. In some embodiments, the first threshold depends on whether IBC AMVP mode or IBC merge mode is used. In some embodiments, the first threshold depends on slice type or picture type.

In some embodiments, a block is allowed to be coded with the IBC-LIC mode when a block size is larger than or equal to a second threshold, where the block size is equal to W×H, and W and H denotes block width and block height of the block, respectively. In some embodiments, the second threshold is equal to one of: 16, 32, 64, 128, or 256. In some embodiments, the second threshold depends on whether IBC AMVP mode or IBC merge mode is used. In some embodiments, the second threshold depends on slice type or picture type. In some embodiments, the block size refers to luma block size.

In some embodiments, an indication of the IBC-LIC mode is indicated based on a condition. Alternatively, the indication of the IBC-LIC mode is derived. In some embodiments, the condition comprises at least one of: whether a target coding method is allowed, a block dimension, a block size, a block depth, a slice type, a picture type, a partition tree type, a temporal layer identification, a block location, or a colour component.

In some embodiments, the indication of the IBC-LIC mode is not indicated when a block size is less than or equal to a third threshold, where the block size is equal to W×H, and W and H denotes block width and block height of the block, respectively. In some embodiments, the third threshold is equal to one of: 256, 512, 1024, 2048 or 4096. In some embodiments, the third threshold depends on whether IBC AMVP mode or IBC merge mode is used. In some embodiments, the third threshold depends on slice type or picture type.

In some embodiments, the indication of the IBC-LIC mode is not indicated when a block size is larger than or equal to a fourth threshold, where the block size is equal to W×H, and W and H denotes block width and block height of the block, respectively. In some embodiments, the fourth threshold is equal to one of: 16, 32, 64, 128, or 256. In some embodiments, the fourth threshold depends on whether IBC AMVP mode or IBC merge mode is used. In some embodiments, the fourth threshold depends on slice type or picture type. In some embodiments, the block size refers to luma block size.

In some embodiments, if the indication of the IBC-LIC mode is not indicated, the indication of the IBC-LIC mode is inferred to be a default value. In some embodiments, if the indication of the IBC-LIC mode is not indicated, the indication of the IBC-LIC mode is inferred to be false. In some embodiments, if the indication of the IBC-LIC mode is not indicated, the indication of the IBC-LIC mode is inferred to be true.

In some embodiments, whether the video unit is coded with an IBC with LIC mode is indicated using at least one syntax element. In some embodiments, the indication of the IBC-LIC mode is not indicated when the video unit is coded with IBC merge mode. In some embodiments, whether a block is allowed to be coded with the IBC-LIC mode depends on one or more syntax elements. In some embodiments, the one or more syntax elements are indicated as general constraints information.

In some embodiments, when a syntax element indicating general constraint on IBC-LIC is equal to a first value, the IBC-LIC mode is not allowed. Alternatively, when either a syntax indicating general constraint on IBC is equal to a second value, the IBC-LIC is not allowed. In some embodiments, the syntax element is gci_no_ibc_constraint_flag. Alternatively, or in addition, the first value is 0 or 1. Alternatively, or in addition, the second value is 0 or 1. In some embodiments, the one or more syntax elements is indicated at one of the followings: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, the video unit comprises at least one of: a color component, a prediction block (PB), a transform block (TB), a coding block (CB), a prediction unit (PU), a transform unit (TU), a coding tree block (CTB), a coding unit (CU), a coding tree unit (CTU), a CTU row, groups of CTU, a slice, a tile, a sub-picture, a block, a sub-region within a block, or a region containing more than one sample or pixel. In some embodiments, an indication of whether to and/or how to derive the refined prediction sample of the video unit by applying the IBC-LIC mode is indicated at one of the followings: sequence level, group of pictures level, picture level, slice level, or tile group level.

In some embodiments, an indication of whether to and/or how to derive the refined prediction sample of the video unit by applying the IBC-LIC mode is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header. In some embodiments, an indication of whether to and/or how to derive the refined prediction sample of the video unit by applying the IBC-LIC mode is indicated at one of the following: a PB, a TB, a CB, a PU, a TU, a CU, a VPDU, a CTU, a CTU row, a slice, a tile, a sub-picture, or a region contains more than one sample or pixel.

In some embodiments, whether to and/or how to derive the refined prediction sample of the video unit by applying the IBC-LIC mode is coded information of the video unit. The coded information may include at least one of a block size, a colour format, a single tree partitioning, a dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: determining, for a conversion between a video unit of a video and a bitstream of the video, whether to apply an intra block copy (IBC) and local illumination compensation (LIC) (IBC-LIC) mode to the video unit; in accordance with a determination of applying the IBC-LIC mode to the video unit, deriving, a refined prediction of the video unit by applying the IBC-LIC mode to the video unit, where deriving the refined prediction of the video unit comprises: obtaining a prediction of the video unit by applying the IBC to the video unit; and obtaining the refined prediction of the video unit by applying the LIC to the prediction; and generating the bitstream based on the refined prediction.

According to still further embodiments of the present disclosure, a method for storing bitstream of a video is provided. The method comprises: determining, for a conversion between a video unit of a video and a bitstream of the video, whether to apply an intra block copy (IBC) and local illumination compensation (LIC) (IBC-LIC) mode to the video unit; in accordance with a determination of applying the IBC-LIC mode to the video unit, deriving, a refined prediction of the video unit by applying the IBC-LIC mode to the video unit, where deriving the refined prediction of the video unit comprises: obtaining a prediction of the video unit by applying the IBC to the video unit; and obtaining the refined prediction of the video unit by applying the LIC to the prediction; generating the bitstream based on the refined prediction; and storing the bitstream in a non-transitory computer-readable recording medium.

Implementations of the present disclosure can be described in view of the following clauses, the features of which can be combined in any reasonable manner.

Clause 1. A method of video processing, comprising: determining, for a conversion between a video unit of a video and a bitstream of the video, whether to apply an intra block copy (IBC) and local illumination compensation (LIC) (IBC-LIC) mode to the video unit; in accordance with a determination of applying the IBC-LIC mode to the video unit, deriving, a refined prediction of the video unit by applying the IBC-LIC mode to the video unit, where deriving the refined prediction of the video unit comprises: obtaining a prediction of the video unit by applying the IBC to the video unit; and obtaining the refined prediction of the video unit by applying the LIC to the prediction; and performing the conversion based on the refined prediction sample.

Clause 2. The method of clause 1, wherein whether to apply the IBC-LIC mode for IBC merge mode is derived.

Clause 3. The method of clause 2, wherein a template matching based approach is used to determine whether to apply the IBC-LIC mode for IBC merge mode.

Clause 4. The method of clause 3, wherein a first cost is calculated between the prediction of a template of the video unit and a reconstruction of the template when the IBC-LIC mode is applied, and wherein a second cost is calculated between the prediction of the template of the video unit and a reconstruction of the template when the IBC-LIC mode is not applied.

Clause 5. The method of clause 4, wherein if the first cost is smaller than or equal to the second cost, the IBC-LIC mode is applied; and/or wherein if the first cost is larger than the second cost, the IBC-LIC mode is not applied.

Clause 6. The method of clause 4, wherein if the first cost is smaller than or equal to the second cost multiplied with a scale factor, the IBC-LIC mode is applied; and/or wherein if the first cost is larger than the second cost multiplied with the scale factor, the IBC-LIC mode is not applied.

Clause 7. The method of clause 4, wherein if the first cost is smaller than or equal to a sum of the second cost and an offset, the IBC-LIC mode is applied; and/or wherein if the first cost is larger than the sum of the second cost and the offset, the IBC-LIC mode is not applied.

Clause 8. The method of clause 1, wherein the IBC-LIC mode is used in a process of reordering a block vector (BV) candidate list.

Clause 9. The method of clause 8, wherein the BV candidate list is at least one of: an IBC advanced motion vector prediction (AMVP) candidate list, or an IBC merge candidate list.

Clause 10. The method of clause 8, wherein the BV candidate list is at least one of: an IBC regular merge list, an IBC template matching (TM) merge list, or an IBC-merge mode with block vector difference (MBVD) merge list.

Clause 11. The method of clause 8, wherein whether to and/or an approach to apply the IBC-LIC mode in the process of reordering BV candidate list is same as that applying the IBC-LIC mode to the video unit.

Clause 12. The method of clause 8, wherein if the IBC-LIC mode is used for a BV candidate, the prediction of a template of the video unit is refined using the IBC-LIC mode.

Clause 13. The method of clause 12, wherein at least one of: neighboring reconstructed samples of a left or above template, or neighboring reconstructed samples of a reference template of the left or above template is used to derive parameters of the IBC-LIC mode.

Clause 14. The method of clause 13, wherein the reference template of the left or above template is derived using a BV associated with the BV candidate.

Clause 15. The method of clause 13, wherein at least one of: the neighboring reconstructed samples of the left or above template, the neighboring reconstructed samples of the reference template of the left or above template, or the left or above template is constrained in an IBC buffer.

Clause 16. The method of clause 13, wherein if at least one of: the neighboring reconstructed samples of the left or above template, the neighboring reconstructed samples of the reference template of the left or above template, or the left or above template is out of an IBC buffer, the IBC-LIC mode is not used.

Clause 17. The method of clause 13, wherein if at least one of: the neighbouring reconstructed samples of the left or above template, the neighbouring reconstructed samples of the reference template of the left or above template, or the left or above template is out of an IBC buffer, samples out of the IBC buffer are padded using samples in the IBC buffer, and the IBC-LIC mode is used.

Clause 18. The method of clause 8, wherein the IBC-LIC mode is applied to one or more BV candidates in the BV candidate list.

Clause 19. The method of clause 18, wherein whether to apply the IBC-LIC mode to a BV candidate depends on a type of the BV candidate.

Clause 20. The method of clause 19, wherein the type of the BV candidate comprises one of: a spatial BV candidate, a history based motion vector prediction (HMVP) BV candidate, a pairwise BV candidate, a default BV candidate, or other types of BV candidate.

Clause 21. The method of clause 8, wherein if a BV candidate is a reconstruction-reordered IBC (RR-IBC), the IBC-LIC mode is not used, or wherein if a BV candidate is a RR-IBC, the IBC-LIC mode is used.

Clause 22. The method of clause 21, wherein an original BV of the BV candidate is used to derive IBC-LIC parameters.

Clause 23. The method of clause 21, wherein an adjusted BV of the BV candidate according to a RR-IBC flip type is used to derive IBC-LIC parameters.

Clause 24. The method of clause 8, wherein a set of IBC-LIC parameters is derived.

Clause 25. The method of clause 24, wherein the derived set of IBC-LIC parameters is used for at least one of: a left template or an above template.

Clause 26. The method of clause 8, wherein a plurality of sets of IBC-LIC parameters are derived.

Clause 27. The method of clause 26, wherein a first set of IBC-LIC parameters in the plurality of sets of IBC-LIC parameters is used for the left template, and/or wherein a second set of IBC-LIC parameters in the plurality of sets of IBC-LIC parameters is used for the above template.

Clause 28. The method of clause 8, wherein whether to and/or an approach to apply the IBC-LIC mode to the BV candidate list reordering depends on a coding tool using the BV candidate list.

Clause 29. The method of clause 28, wherein the IBC-LIC mode is applied to the process of reordering the BV candidate list, if the coding tool is at least one of: an IBC AMVP mode, an IBC regular merge mode, an IBC TM merge mode, or an IBC-MBVD merge mode.

Clause 30. The method of clause 28, wherein the IBC-LIC mode is not applied to the process of reordering the BV candidate list, if the coding tool is at least one of: an IBC AMVP mode, an IBC regular merge mode, an IBC TM merge mode, or an IBC-MBVD merge mode.

Clause 31. The method of clause 1, wherein if RR-IBC is used, the IBC-LIC mode is used.

Clause 32. The method of clause 31, wherein at least one of: positions or shapes of a template used for LIC depends on whether RR-IBC is applied.

Clause 33. The method of clause 31, wherein an original BV without adjusted according to a RR-IBC flip type is used to derive IBC-LIC parameters.

Clause 34. The method of clause 31, wherein an adjusted BV according to the RR-IBC flip type is used to derive IBC-LIC parameters.

Clause 35. The method of clause 31, wherein an original template of a reference block is used to derive IBC-LIC parameters.

Clause 36. The method of clause 35, wherein the original template of the reference block is constrained in an IBC buffer.

Clause 37. The method of clause 35, wherein if the original template is not in an IBC buffer, the IBC-LIC mode is not used.

Clause 38. The method of clause 35, wherein if the original template is not in the IBC buffer, the original template is padded using samples in an IBC buffer and the padded original template is used in the IBC-LIC mode.

Clause 39. The method of clause 31, wherein an adjusted template of a reference block is used to derive IBC-LIC parameters.

Clause 40. The method of clause 39, wherein the adjusted template of the reference block is constrained in an IBC buffer.

Clause 41. The method of clause 39, wherein the adjusted template of the reference block is adjusted according to an RR-IBC flip type.

Clause 42. The method of clause 41, wherein if the RR-IBC flip type is horizontal, the adjusted left and above template of the reference template is used.

Clause 43. The method of clause 41, wherein if the RR-IBC flip type is vertical, the adjusted left and above template of the reference template is used.

Clause 44. The method of clause 39, wherein if the adjusted template is not in an IBC buffer, the IBC-LIC mode is not used.

Clause 45. The method of clause 39, wherein if the adjusted template is not in an IBC buffer, the adjusted template is padded using samples in the IBC buffer and then the padded template is used in the IBC-LIC mode.

Clause 46. The method of clause 31, wherein the IBC-LIC mode is used with a RR-IBC flip type.

Clause 47. The method of clause 46, wherein the RR-IBC flip type is horizontal, or wherein the RR-IBC flip type is vertical.

Clause 48. The method of any of clauses 1-47, wherein whether to and/or an approach to apply the IBC-LIC mode depends on coding information of the video unit, and wherein the coding information of the video unit comprises at least one of: a block dimension, a block size, a depth of the video unit, a slice type, a picture type, a partition tree type, a block location, a quantization parameter, or a colour component.

Clause 49. The method of clause 48, wherein a block is allowed to be coded with the IBC-LIC mode when a block size is less than or equal to a first threshold, wherein the block size is equal to W×H, and W and H denotes block width and block height of the block, respectively.

Clause 50. The method of clause 49, wherein the first threshold is equal to one of: 256, 512, 1024, 2048 or 4096.

Clause 51. The method of clause 49, wherein the first threshold depends on whether IBC AMVP mode or IBC merge mode is used.

Clause 52. The method of clause 49, wherein the first threshold depends on slice type or picture type.

Clause 53. The method of clause 48, wherein a block is allowed to be coded with the IBC-LIC mode when a block size is larger than or equal to a second threshold, wherein the block size is equal to W×H, and W and H denotes block width and block height of the block, respectively.

Clause 54. The method of clause 53, wherein the second threshold is equal to one of: 16, 32, 64, 128, or 256.

Clause 55. The method of clause 53, wherein the second threshold depends on whether IBC AMVP mode or IBC merge mode is used.

Clause 56. The method of clause 53, wherein the second threshold depends on slice type or picture type.

Clause 57. The method of any of clauses 48-53, wherein the block size refers to luma block size.

Clause 58. The method of clause 1, wherein an indication of the IBC-LIC mode is indicated based on a condition, or wherein the indication of the IBC-LIC mode is derived.

Clause 59. The method of clause 58, wherein the condition comprises at least one of: whether a target coding method is allowed, a block dimension, a block size, a block depth, a slice type, a picture type, a partition tree type, a temporal layer identification, a block location, or a colour component.

Clause 60. The method of clause 59, wherein the indication of the IBC-LIC mode is not indicated when a block size is less than or equal to a third threshold, wherein the block size is equal to W×H, and W and H denotes block width and block height of the block, respectively.

Clause 61. The method of clause 60, wherein the third threshold is equal to one of: 256, 512, 1024, 2048 or 4096.

Clause 62. The method of clause 60, wherein the third threshold depends on whether IBC AMVP mode or IBC merge mode is used.

Clause 63. The method of clause 60, wherein the third threshold depends on slice type or picture type.

Clause 64. The method of clause 59, wherein the indication of the IBC-LIC mode is not indicated when a block size is larger than or equal to a fourth threshold, wherein the block size is equal to W×H, and W and H denotes block width and block height of the block, respectively.

Clause 65. The method of clause 64, wherein the fourth threshold is equal to one of: 16, 32, 64, 128, or 256.

Clause 66. The method of clause 64, wherein the fourth threshold depends on whether IBC AMVP mode or IBC merge mode is used.

Clause 67. The method of clause 64, wherein the fourth threshold depends on slice type or picture type.

Clause 68. The method of any of clauses 59-67, wherein the block size refers to luma block size.

Clause 69. The method of clause 58, wherein if the indication of the IBC-LIC mode is not indicated, the indication of the IBC-LIC mode is inferred to be a default value.

Clause 70. The method of clause 69, wherein if the indication of the IBC-LIC mode is not indicated, the indication of the IBC-LIC mode is inferred to be false.

Clause 71. The method of clause 69, wherein if the indication of the IBC-LIC mode is not indicated, the indication of the IBC-LIC mode is inferred to be true.

Clause 72. The method of clause 1, wherein whether the video unit is coded with an IBC with LIC mode is indicated using at least one syntax element.

Clause 73. The method of clause 72, wherein the indication of the IBC-LIC mode is not indicated when the video unit is coded with IBC merge mode.

Clause 74. The method of clause 27, wherein whether a block is allowed to be coded with the IBC-LIC mode depends on one or more syntax elements.

Clause 75. The method of clause 74, wherein the one or more syntax elements are indicated as general constraints information.

Clause 76. The method of clause 75, wherein when a syntax element indicating general constraint on IBC-LIC is equal to a first value, the IBC-LIC mode is not allowed, or wherein when either a syntax indicating general constraint on IBC is equal to a second value, the IBC-LIC is not allowed.

Clause 77. The method of clause 76, wherein the syntax element is gci_no_ibc_constraint_flag, and/or wherein the first value is 0 or 1, and/or wherein the second value is 0 or 1.

Clause 78. The method of clause 74, wherein the one or more syntax elements is indicated at one of the followings: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 79. The method of any of clauses 1-78, wherein the video unit comprises at least one of: a color component, a prediction block (PB), a transform block (TB), a coding block (CB), a prediction unit (PU), a transform unit (TU), a coding tree block (CTB), a coding unit (CU), a coding tree unit (CTU), a CTU row, groups of CTU, a slice, a tile, a sub-picture, a block, a sub-region within a block, or a region containing more than one sample or pixel.

Clause 80. The method of any of clauses 1-78, wherein an indication of whether to and/or how to derive the refined prediction sample of the video unit by applying the IBC-LIC mode is indicated at one of the followings: sequence level, group of pictures level, picture level, slice level, or tile group level.

Clause 81. The method of any of clauses 1-78, wherein an indication of whether to and/or how to derive the refined prediction sample of the video unit by applying the IBC-LIC mode is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 82. The method of any of clauses 1-78, wherein an indication of whether to and/or how to derive the refined prediction sample of the video unit by applying the IBC-LIC mode is indicated at one of the following: a PB, a TB, a CB, a PU, a TU, a CU, a VPDU, a CTU, a CTU row, a slice, a tile, a sub-picture, or a region contains more than one sample or pixel.

Clause 83. The method of any of clauses 1-78, wherein whether to and/or how to derive the refined prediction sample of the video unit by applying the IBC-LIC mode is coded information of the video unit, and wherein the coded information comprises at least one of a block size, a colour format, a single tree partitioning, a dual tree partitioning, a colour component, a slice type, or a picture type.

Clause 84. The method of any of clauses 1-78, wherein the conversion includes encoding the video unit into the bitstream.

Clause 85. The method of any of clauses 1-78, wherein the conversion includes decoding the video unit from the bitstream.

Clause 86. An apparatus for video processing comprising a processor and a non-transitory memory with instructions thereon, wherein the instructions upon execution by the processor, cause the processor to perform a method in accordance with any of clauses 1-85.

Clause 87. A non-transitory computer-readable storage medium storing instructions that cause a processor to perform a method in accordance with any of clauses 1-85.

Clause 88. A non-transitory computer-readable recording medium storing a bitstream of a video which is generated by a method performed by an apparatus for video processing, wherein the method comprises: determining, for a conversion between a video unit of a video and a bitstream of the video, whether to apply an intra block copy (IBC) and local illumination compensation (LIC) (IBC-LIC) mode to the video unit; in accordance with a determination of applying the IBC-LIC mode to the video unit, deriving, a refined prediction of the video unit by applying the IBC-LIC mode to the video unit, wherein deriving the refined prediction of the video unit comprises: obtaining a prediction of the video unit by applying the IBC to the video unit; and obtaining the refined prediction of the video unit by applying the LIC to the prediction; and generating the bitstream based on the refined prediction.

Clause 89. A method for storing a bitstream of a video, comprising: determining, for a conversion between a video unit of a video and a bitstream of the video, whether to apply an intra block copy (IBC) and local illumination compensation (LIC) (IBC-LIC) mode to the video unit; in accordance with a determination of applying the IBC-LIC mode to the video unit, deriving, a refined prediction of the video unit by applying the IBC-LIC mode to the video unit, wherein deriving the refined prediction of the video unit comprises: obtaining a prediction of the video unit by applying the IBC to the video unit; and obtaining the refined prediction of the video unit by applying the LIC to the prediction; generating the bitstream based on the refined prediction; and storing the bitstream in a non-transitory computer-readable recording medium.

### Example Device

FIG. 21 illustrates a block diagram of a computing device 2100 in which various embodiments of the present disclosure can be implemented. The computing device 2100 may be implemented as or included in the source device 110 (or the video encoder 114 or 200) or the destination device 120 (or the video decoder 124 or 300).

It would be appreciated that the computing device 2100 shown in FIG. 21 is merely for purpose of illustration, without suggesting any limitation to the functions and scopes of the embodiments of the present disclosure in any manner.

As shown in FIG. 21, the computing device 2100 includes a general-purpose computing device 2100. The computing device 2100 may at least comprise one or more processors or processing units 2110, a memory 2120, a storage unit 2130, one or more communication units 2140, one or more input devices 2150, and one or more output devices 2160.

In some embodiments, the computing device 2100 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2100 can support any type of interface to a user (such as “wearable” circuitry and the like).

The processing unit 2110 may be a physical or virtual processor and can implement various processes based on programs stored in the memory 2120. In a multi-processor system, multiple processing units execute computer executable instructions in parallel so as to improve the parallel processing capability of the computing device 2100. The processing unit 2110 may also be referred to as a central processing unit (CPU), a microprocessor, a controller or a microcontroller.

The computing device 2100 typically includes various computer storage medium. Such medium

can be any medium accessible by the computing device 2100, including, but not limited to, volatile and non-volatile medium, or detachable and non-detachable medium. The memory 2120 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2130 may be any detachable or non-detachable medium and may include a machine-readable medium such as a memory, flash memory drive, magnetic disk or another other media, which can be used for storing information and/or data and can be accessed in the computing device 2100.

The computing device 2100 may further include additional detachable/non-detachable, volatile/non-volatile memory medium. Although not shown in FIG. 21, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2140 communicates with a further computing device via the communication medium. In addition, the functions of the components in the computing device 2100 can be implemented by a single computing cluster or multiple computing machines that can communicate via communication connections. Therefore, the computing device 2100 can operate in a networked environment using a logical connection with one or more other servers, networked personal computers (PCs) or further general network nodes.

The input device 2150 may be one or more of a variety of input devices, such as a mouse, keyboard, tracking ball, voice-input device, and the like. The output device 2160 may be one or more of a variety of output devices, such as a display, loudspeaker, printer, and the like. By means of the communication unit 2140, the computing device 2100 can further communicate with one or more external devices (not shown) such as the storage devices and display device, with one or more devices enabling the user to interact with the computing device 2100, or any devices (such as a network card, a modem and the like) enabling the computing device 2100 to communicate with one or more other computing devices, if required. Such communication can be performed via input/output (I/O) interfaces (not shown).

In some embodiments, instead of being integrated in a single device, some or all components of the computing device 2100 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2100 may be used to implement video encoding/decoding in embodiments of the present disclosure. The memory 2120 may include one or more video coding modules 2125 having one or more program instructions. These modules are accessible and executable by the processing unit 2110 to perform the functionalities of the various embodiments described herein.

In the example embodiments of performing video encoding, the input device 2150 may receive video data as an input 2170 to be encoded. The video data may be processed, for example, by the video coding module 2125, to generate an encoded bitstream. The encoded bitstream may be provided via the output device 2160 as an output 2180.

In the example embodiments of performing video decoding, the input device 2150 may receive an encoded bitstream as the input 2170. The encoded bitstream may be processed, for example, by the video coding module 2125, to generate decoded video data. The decoded video data may be provided via the output device 2160 as the output 2180.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/we claim:

1. A method of video processing, comprising:
determining, for a conversion between a video unit of a video and a bitstream of the video, whether to apply an intra block copy (IBC) and local illumination compensation (LIC) (IBC-LIC) mode to the video unit;
in accordance with a determination of applying the IBC-LIC mode to the video unit, deriving, a refined prediction of the video unit by applying the IBC-LIC mode to the video unit, wherein deriving the refined prediction of the video unit comprises:
obtaining a prediction of the video unit by applying the IBC to the video unit; and
obtaining the refined prediction of the video unit by applying the LIC to the prediction; and
performing the conversion based on the refined prediction.

2. The method of claim 1, wherein whether to apply the IBC-LIC mode for IBC merge mode is derived.

3. The method of claim 2, wherein a template matching based approach is used to determine whether to apply the IBC-LIC mode for IBC merge mode.

4. The method of claim 1, wherein the IBC-LIC mode is used in a process of reordering a block vector (BV) candidate list.

5. The method of claim 4, wherein the BV candidate list is at least one of:
an IBC advanced motion vector prediction (AMVP) candidate list, or
an IBC merge candidate list.

6. The method of claim 4, wherein the BV candidate list is at least one of:
an IBC regular merge list,
an IBC template matching (TM) merge list, or
an IBC-merge mode with block vector difference (MBVD) merge list.

7. The method of claim 4, wherein whether to and/or an approach to apply the IBC-LIC mode in the process of reordering BV candidate list is same as that applying the IBC-LIC mode to the video unit.

8. The method of claim 4, wherein if the IBC-LIC mode is used for a BV candidate, the prediction of a template of the video unit is refined using the IBC-LIC mode.

9. The method of claim 4, wherein the IBC-LIC mode is applied to one or more BV candidates in the BV candidate list.

10. The method of claim 9, wherein whether to apply the IBC-LIC mode to a BV candidate depends on a type of the BV candidate.

11. The method of claim 4, wherein if a BV candidate is a reconstruction-reordered IBC (RR-IBC), the IBC-LIC mode is not used.

12. The method of claim 4, wherein a set of IBC-LIC parameters is derived.

13. The method of claim 12, wherein the derived set of IBC-LIC parameters is used for at least one of:
a left template or an above template.

14. The method of claim 4, wherein a plurality of sets of IBC-LIC parameters are derived, and/or
wherein whether to and/or an approach to apply the IBC-LIC mode to the BV candidate list reordering depends on a coding tool using the BV candidate list.

15. The method of claim 1, wherein an indication of the IBC-LIC mode is indicated based on a condition, or
wherein the indication of the IBC-LIC mode is derived.

16. The method of claim 1, wherein whether the video unit is coded with an IBC with LIC mode is indicated using at least one syntax element.

17. The method of claim 1, wherein the conversion includes encoding the video unit into the bitstream, or
wherein the conversion includes decoding the video unit from the bitstream.

18. An apparatus for video processing comprising a processor and a non-transitory memory with instructions thereon, wherein the instructions upon execution by the processor, cause the processor to perform a method comprising
determining, for a conversion between a video unit of a video and a bitstream of the video, whether to apply an intra block copy (IBC) and local illumination compensation (LIC) (IBC-LIC) mode to the video unit;
in accordance with a determination of applying the IBC-LIC mode to the video unit, deriving, a refined prediction of the video unit by applying the IBC-LIC mode to the video unit, wherein deriving the refined prediction of the video unit comprises:
obtaining a prediction of the video unit by applying the IBC to the video unit; and
obtaining the refined prediction of the video unit by applying the LIC to the prediction; and
performing the conversion based on the refined prediction.

19. A non-transitory computer-readable storage medium storing instructions that cause a processor to perform a method comprising
determining, for a conversion between a video unit of a video and a bitstream of the video, whether to apply an intra block copy (IBC) and local illumination compensation (LIC) (IBC-LIC) mode to the video unit;
in accordance with a determination of applying the IBC-LIC mode to the video unit, deriving, a refined prediction of the video unit by applying the IBC-LIC mode to the video unit, wherein deriving the refined prediction of the video unit comprises:
obtaining a prediction of the video unit by applying the IBC to the video unit; and
obtaining the refined prediction of the video unit by applying the LIC to the prediction; and
performing the conversion based on the refined prediction.

20. A non-transitory computer-readable recording medium storing a bitstream of a video which is generated by a method performed by an apparatus for video processing, wherein the method comprises:
determining, for a conversion between a video unit of a video and a bitstream of the video, whether to apply an intra block copy (IBC) and local illumination compensation (LIC) (IBC-LIC) mode to the video unit;
in accordance with a determination of applying the IBC-LIC mode to the video unit, deriving, a refined prediction of the video unit by applying the IBC-LIC mode to the video unit, wherein deriving the refined prediction of the video unit comprises:
obtaining a prediction of the video unit by applying the IBC to the video unit; and
obtaining the refined prediction of the video unit by applying the LIC to the prediction; and
generating the bitstream based on the refined prediction.
